(19) United States
(12) Patent Application Publication
(10) Pub. No.: US 2026/0313248 A1
(43) Pub. Date: Oct. 8, 2026

(54) SYSTEM AND APPARATUS FOR IMAGE SENSING AND PROCESSING

(71) Applicant: Hussein Ali, Foothill Ranch, CA (US)

(72) Inventor: Hussein Ali, Foothill Ranch, CA (US)

(21) Appl. No.: 19/465,293

(22) Filed: Jan. 30, 2026

Related U.S. Application Data
(60) Provisional application No. 63/782,754, filed on Apr. 3, 2025.

(51) Int. Cl. H04N 25/13; H04N 25/77; H04N 25/778

(52) U.S. Cl. CPC H04N 25/134; H04N 25/77; H04N 25/778

(57) ABSTRACT

Optimization may be achieved within imaging systems through codesign of sensors and communication links to digital processors, highlighting shorter latency processing and faster feedback cycles. Examples of the optimization include vertical integration using 3-die and 2-die stacking processes for efficient event and image processing. Furthermore, on-chip augmented artificial intelligence for feature extraction and minimized data transmission further include optimization benefits.

### RELATED APPLICATIONS

This application claims the priority of U.S. Provisional Application No. 63/782,754, entitled “SYSTEM AND APPARATUS FOR IMAGE SENSING AND PROCESSING” filed on Apr. 3, 2025, the disclosure of which is hereby incorporated by reference in its entirety.

### BACKGROUND OF THE INVENTION

Frame-based cameras, despite their effectiveness in computer vision, exhibit limitations such as high latency, low dynamic range, high power consumption, and motion blur. For decades, development has been made toward neuromorphic cameras, which operate differently from traditional frame-based types, mimicking biological vision systems for better data acquisition and spatio-temporal resolution. In neuromorphic cameras, each pixel captures intensity changes in the scene above certain system-defined thresholds, and streams of events are captured. However, the data captured by these sensors mean that traditional computer vision techniques are not directly applicable. Furthermore, conventional image Sensors and image processing are done on-chip on the same die, or in a stack of multiple dies, called 3D stacking. FIG. 1 shows the 3-die stacking in prior art, which consists of Top Die for pixel array, Middle Die for Read-Out Integrated Circuits, and Bottom Die for Image Signal Processing.

The image sensor consists of an array of light-sensitive elements, called the pixel. The pixel can have multiple configurations and/or multiple types. Frame-based CMOS Image Sensors have several drawbacks, particularly in high-speed or high-resolution imaging applications. Achieving higher speed typically accompanied by a significant increase in power dissipation, which can lead to higher heat accumulation. Excess heat affects the reliability of the sensor, and adds thermal noise, degrading image quality. Other drawbacks include data deluge, with significant amount of redundant information, leading to a bottleneck at the sensor interface. Frame-based sensors are also limited in flexibility for AI-enabled sensor design, since they transmit the information without capturing the intelligibility of the scene dynamics, making edge-computing more difficult. Accordingly, there is a need to address the shortcomings of frame based cameras and exploit the potential of neuromorphic sensors.

### SUMMARY OF THE INVENTION

Image Sensor system comprises a unique arrangement of Color Filter Array to combine Dynamic Vision Sensor pixel with Active Pixel Sensor in a pixel unit. This combined structure is repeated in the pixel array. In a stacked CMOS process, this structure permits smaller DVS pixel on the pixel die, while allowing larger area for the DVS circuitry on the Read-Out Integrated Circuit die. This structure is more suitable for image reconstruction and interpolation.

The DVS frames and the APS frames are synchronized, where the status of the DVS pixels is registered and checked at the same time when the APS pixel exposure ends. This simplifies the post-processing and makes the image reconstruction significantly more accurate.

The DVS pixels can reduce the amount of data, which is getting out of the sensor, and reduce the output data rate, by discarding the APS pixels which surround inactive DVS ones. The inactive DVS pixel is the one which registers no event.

The background illumination is measured and calculated, and it is post-processed to Auto-Tune the contrast levels of the DVS pixels. Further, this background light information is used to perform DVS-Based Auto-Exposure for the APS pixel.

The DVS pixel and APS pixels are configured in the pixel unit. The 3D stacking process is exploited to do Analog-to-Digital-Conversion of both the DVS pixel and the APS pixels in a separate die, where an ADC per pixel unit, or a cluster of pixel unit, converts the light information into digital for post-processing.

A configuration of communication links between the pixel array outputs and the digital processor minimizes the processing latency and reduces the power of sending this data off-chip. Further, the digital processor can be custom, and consists of an array of Vision Processors Units, which enables fast post-processing, and presents a high potential for an augmented AI on-chip. The VPUs can be programmed for features' extraction and inference, to construct an Inference Programmable Gate Array ‘IPGA’. Examples are discussed in additional detail in U.S. Patent Application No. ______, filed ______ and entitled “SPATIO-TEMPORAL ULTRA-EFFICIENT NEUROMORPHIC SENSOR WITH A PROGRAMMABLE COMPUTE-IN-PIXEL SPATIO-TEMPORAL EVENT-BASED CAMERA WITH FEATURE-ON-DEMAND READOUT,” which is hereby incorporated by reference in its entirety.

Embodiments of the innovative systems and methods described here include a pixel array comprising a first pixel unit composed of a first microlens, a first color filter, and a first photodiode; a second pixel unit composed of a second microlens, a second color filter, and a second photodiode; a third pixel unit composed of a first microlens, a third color filter, and a third photodiode; a fourth pixel unit composed of a fourth microlens, a fourth color filter, and a fourth photodiode. The pixel array may also include a quadrant pixel array composed of the first, second, third and fourth pixel units wherein the quadrant pixel unit includes a plurality of active pixel sensors and one or more dynamic vision sensors.

In one implementation, the plurality of active pixel sensors is associated with a primary color filter. The one of the one or more dynamic vision sensors may also be uniformly distributed among the plurality of active pixel sensors. In one embodiment, one or more dynamic vision sensors include an all-pass color filter. The pixel array may also include a plurality of quadrant pixel arrays and a quad Bayer color filter array wherein a group of adjacent pixels within the quad Bayer color filter array are set to a single primary color filter. The pixel array may incorporate an augmented on chip artificial intelligence component.

A system for image sensing and processing may include an active pixel sensor circuit including a photodiode, a three-transistor design and an analog to digital converter; an integration dynamic vision sensor including an integration capacitor, an amplifier, a dual comparator, an output and reset logic block and a readout block; and a synchronization timing including a transfer gate signal, a reset signal and a global synchronization signal, the synchronization rendering alignment between an active pixel sensor frame and an integration dynamic vision sensor frame.

The system may further include an interface circuit embedding a function of the active pixel sensor within the integration dynamic vision sensor. According to one embodiment, the photodiode may be shared between the active pixel sensor circuit and the integration dynamic vision sensor via dual parallel circuitry providing a plurality of distinct pathways for data processing. In one implementation, the system includes a current copier copying a current from the photodiode and integrating the current on the integration capacitor. The image sensing system may perform synchronization timing with a rolling shutter or global shutter. In one embodiment, the synchronization timing includes a scene synchronization between a plurality of active pixel sensor frames and a plurality of integration dynamic vision sensor frames. The synchronization timing may enable data filtering of the plurality of active pixel sensor frames based, at least in part, on one or more integration dynamic pixel sensor status variables.

The system for image sensing and processing may further include a background illumination block, a current summation and sense block, an adaptive auto-exposure block, and an adaptive contrast level auto-tune block. The current summation and sense block may sense and sum an aggregate current representative of a plurality of integration dynamic vision sensor currents. With that information, a background illumination level may be determined. The adaptive auto-exposure block may adjust a pixel exposure time based, at least in part, on the background illumination level. The adaptive contrast level auto-tune block may adjust a positive threshold and a negative threshold at the dual comparator based, at least in part, on the background illumination level.

### BRIEF DESCRIPTION OF THE FIGURES

FIG. 1 illustrates one embodiment of a 3D stacking CMOS sensor.

FIG. 2 illustrates one embodiment of a multiple-die configuration for a stacked CIS process.

FIG. 3 illustrates one embodiment of a pixel unit.

FIG. 4 illustrates one embodiment of a pixel unit array.

FIG. 5 illustrates one embodiment of DVS pixel circuitry.

FIG. 6a illustrates one embodiment of APS pixel circuitry and the corresponding synchronization timing.

FIG. 6b illustrates one embodiment of an iDVS pixel with APS function and event detection.

FIG. 6c illustrates one embodiment of an iDVS pixel using current copier circuit.

FIG. 7 illustrates one embodiment of synchronization of a DVS with rolling shutter and global shutter APS.

FIG. 8 illustrates one embodiment of scene synchronization between the DVS and APS frames.

FIG. 9 illustrates one embodiment of event-based APS data filtering.

FIG. 10 illustrates one embodiment of APS Auto-Exposure and DVS Auto-Tune using the background light detection.

FIG. 11 illustrates one embodiment of a 3D CIS stacking process.

FIG. 12 illustrates one embodiment of a pixel unit with ADC per DVS pixel and APS routing to periphery ADC.

FIG. 13 illustrates one embodiment of a pixel array conversion in the Hybrid sensor.

FIG. 14 illustrates one embodiment of an ADC per pixel unit for DVS+APS signal conversion.

FIG. 15 illustrates one embodiment of a pixel array conversion with ADC per pixel unit.

FIG. 16 illustrates one embodiment of a vertical integration of the sensor pixel array, with ROIC and VPU.

FIG. 17 illustrates one embodiment of routing in the vertical integration with the 3D stack CIS process.

FIG. 18 illustrates one embodiment of vertical integration of pixel ROIC and VPU in a 2-die stacking process.

FIG. 19 illustrates one embodiment of communication links between the pixel ROIC and the VPUs in 2-die stacking process.

FIG. 20 illustrates a schematic diagram of a system for image sensing and processing.

### DETAILED DESCRIPTION OF THE INVENTION

The present invention is described in the following examples, which are set forth to aid in the understanding of the invention and should not be construed to limit in any way the scope of the invention as defined in the claims which follow thereafter.

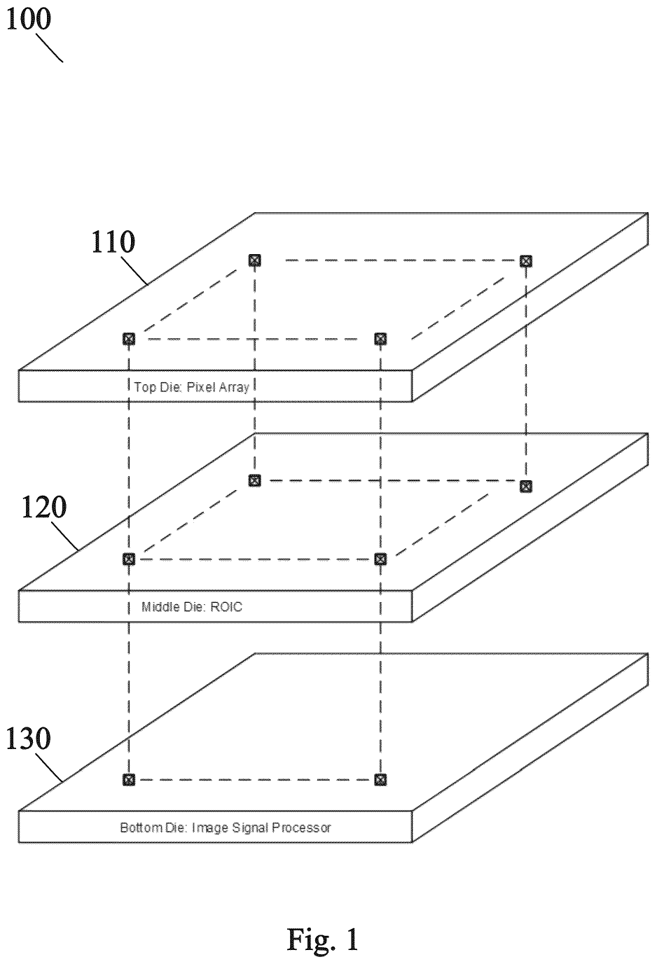

FIG. 1 illustrates one embodiment of a 3D stacking CMOS sensor 100. As shown, FIG. 1 illustrates a Top Die (Pixel Array) 110, a Middle Die (Readout Integrated Circuit ROIC) 120 and a Bottom Die (Image Signal Processor) 130. The top die (pixel array) 110 may include a plurality of photodiodes responsible for converting light or photons into electrical charges. The middle die (ROIC) is an intermediate layer handling signal amplification and conversion of electrical charges received from the photodiodes. In one embodiment, the middle die 120 may include a plurality of pixel transistors (e.g., reset, select, amplify, and the like), analog-to-digital converters (ADC), high speed buffer memory and correlated double sampling circuits. The bottom die 130 may handle the advanced processing and control functions. For example, the image signal processor may manage the incoming data stream, perform noise reduction, manage the control and timing circuits by generating signals to operate the sensor, and format and output processed data to external systems via an output interface.

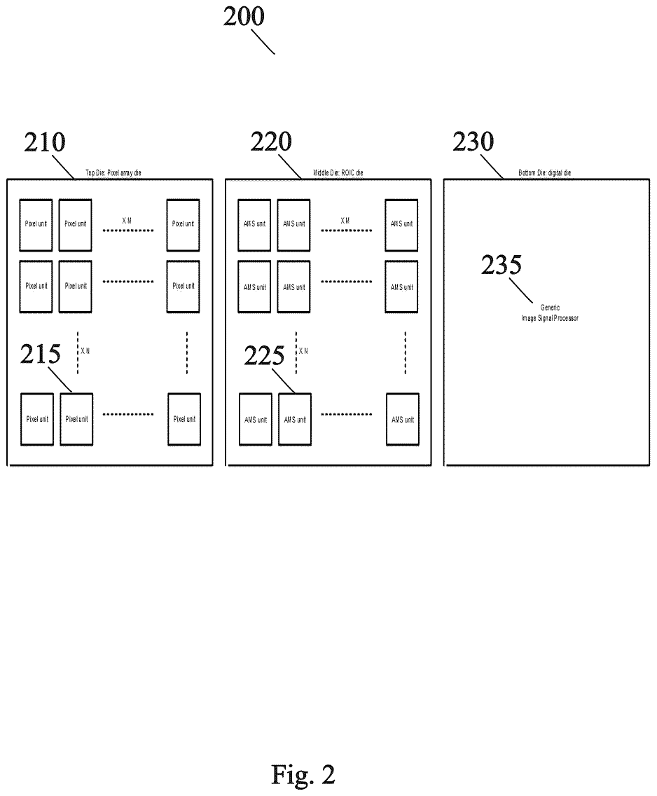

FIG. 2 illustrates one embodiment of a multiple-die configuration 200 for a stacked CIS process. The hybrid sensor consists of an array of pixel units, and this pixel unit consists of two-pixel types or more. FIG. 2 shows the configuration of the 3-die stacking in CMOS Image Sensors. The top die 210 is used for the pixel array, the middle die 220 is for the ROIC, and the bottom die 230 is for the ISP. The top die (pixel array) 110 may include a plurality of pixel units responsible for converting light or photons into electrical charges. The middle die (ROIC) is an intermediate layer handling signal amplification and conversion of electrical charges received from the photodiodes. The middle layer may also include an array of Analog and Mixed Signal ‘AMS’ units 225. The bottom die 130 may handle the advanced processing and control functions. For example, the image signal processor 235 may manage the incoming data stream, perform noise reduction and advanced image and color processing to optimize the image quality, manage the control and timing circuits by generating signals to operate the sensor, and format and output processed data to external systems via an output interface.

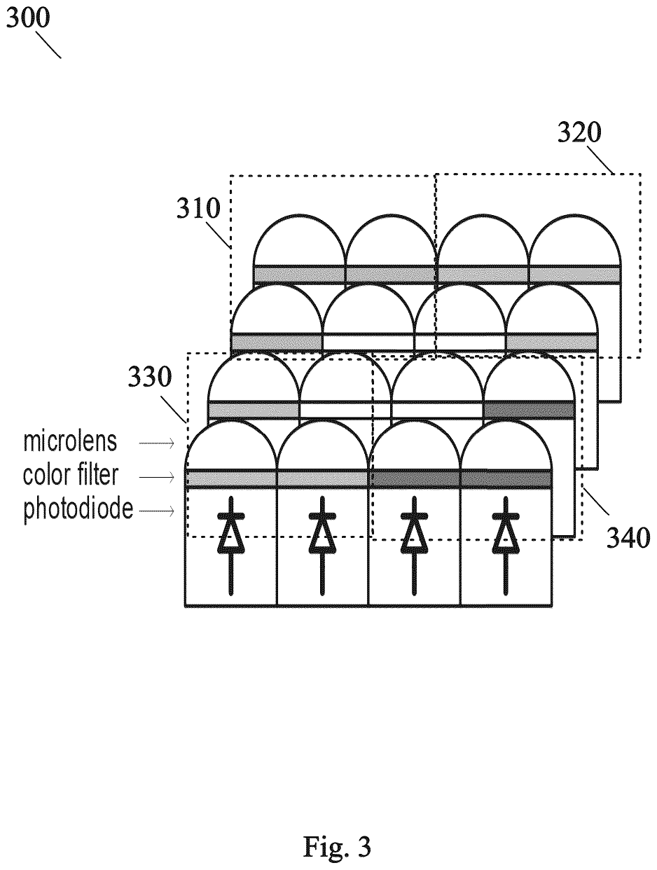

FIG. 3 illustrates one embodiment of a pixel unit 300. The DVS pixel can detect changes in the scene without the need of exposure time. It does this with low latency and high dynamic range. While the DVS pixel can rapidly detect movements in the scene, it cannot output normal images as in the conventional cameras. Conventional cameras use APS pixels, which give high quality images, yet with lower speed, and outputs large quantity of data, with high and useless redundancy. The pixel unit 300 of FIG. 3 illustrates a pixel with three component parts: a microlens or a group of microlenses, a color filter or a group of color filters, and a photodiode or a group of photodiodes. The pixel unit may be segregated into quadrants with specific color filters and different types of pixels. For example, quadrant 310 may be associated with blue filters and an all-pass filter, with APS pixels on the edges and a DVS pixel at the center. Quadrant 320 and quadrant 330 may be associated with green filters and all-pass filters, with APS pixels on the edges and DVS pixels at the center. Additionally, quadrant 340 may be associated with red filters and an all-pass filter, with APS pixels on the edges and a DVS pixel at the center. The four DVS pixels at the center could be combined into one bigger DVS pixel. Other configurations may be implemented as understood by those having skill in the art.

Hybrid sensors are used to get the best of the two worlds-DVS pixels for motion detection with minimal redundancy and high speed, and APS pixels for high quality images. We propose multiple innovations to further push the limits of hybrid sensors and make them suitable for mainstream imaging. The innovations discussed herein pave the way for efficient processing and Augmented-AI on-chip. Specific innovations include the pixel unit configuration, the synchronization between DVS and APS frames, Event-Based APS data filtering, Adaptive Auto-Exposure, Adaptive DVS Auto-Tune, and the codesign of processing-communication links with the pixel array outputs.

The pixel unit pattern is shown in FIG. 3, where each pixel has a microlens, a color filter, and a PhotoDiode that is configured to be DVS with all-pass color filter, or APS with Red Green Blue color filters In one embodiment, augmented-AI on-chip may be performed by the image signal processor layer with a dedicated AI accelerator or neural processing units (NPUs). By placing the augmented AI capabilities on the chip, the system allows for more energy efficient and secure processing at the edge without relying on cloud connectivity. Some AI capabilities may include real time object detection and tracking, features' extraction and inference, enhanced image quality through AI-powered noise reduction and image optimization, and predictive analytics.

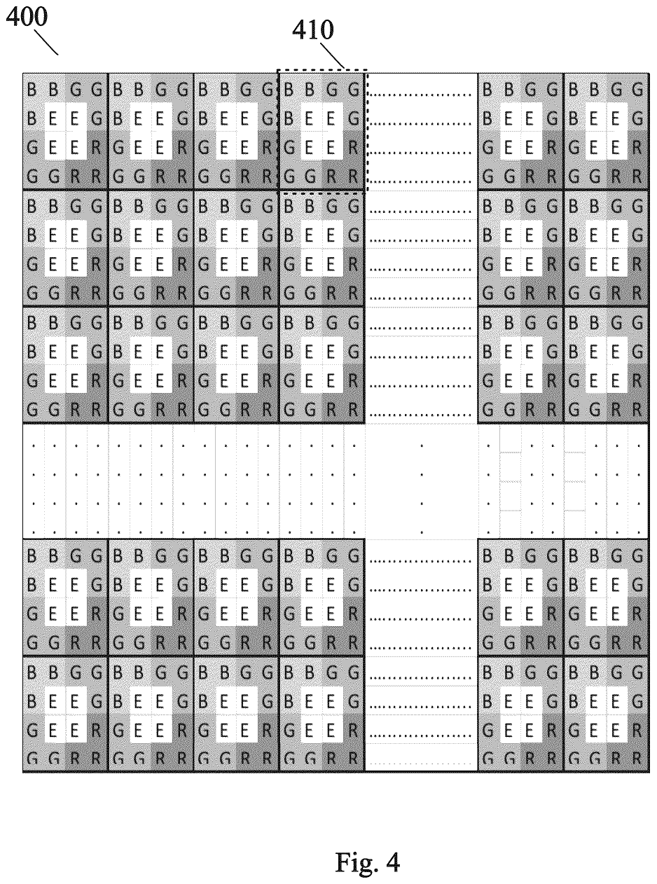

FIG. 4 illustrates one embodiment of a pixel unit array 400. FIG. 4 further illustrates a plane view of the pixel unit array, where each pixel unit pattern 410 has the Event-Based DVS pixel, E, uniformly distributed among the APS pixel colors, RGB, and replacing each color with the same proportion in the Quad-Bayer Color Filter Array. A Quad-Bayer Color Filter Array (CFA) is an image sensor design in which adjacent groups of four pixels (a 2×2 grid) are covered by a color filter of the same color (Red, Green, or Blue). This differs from a conventional Bayer filter, where each individual pixel has its own unique color filter in an alternating pattern. The Quad Bayer approach permits flexibility, allowing the sensor to operate in two distinct modes to optimize image quality based on lighting conditions. For example, in low-light conditions, the four adjacent pixels of the same color can have their data combined or “binned” into a single, larger “super-pixel” (effectively quartering the sensor's total resolution). Bright-Light Conditions (High Resolution): In well-lit scenarios, the sensor can use remosaicing or array conversion to treat each of the four photosites individually, generating a full-resolution image that captures finer detail. Additionally, the design may allow for single-shot HDR by capturing different exposure levels simultaneously using the DVS pixel within the pixel unit (see, e.g., FIGS. 3, 300), which helps manage high-contrast scenes without the ghosting artifacts that can occur with multi-frame HDR methods.

This pattern makes the hybrid sensor more streamlined in the image sensors ecosystem, by exploiting the demosaicing algorithm for Quad-Bayer CFA. Demosaicing (or debayering) is the process of reconstructing a full-color image from the Bayer filter array (BFA) used in most digital image sensors. Since each pixel in a CMOS sensor captures only one color (Red, Green, or Blue), demosaicing algorithms interpolate the missing color values to generate a complete RGB image. Since each pixel captures only one color, the missing two color values (for example, a green pixel lacks red and blue) must be estimated from neighboring pixels. Examples of Demosaicing Algorithms include basic interpolation methods such as nearest neighbor, bilinear interpolation and bicubic interpolation. Additionally, demosaicing algorithms may include edge-aware interpolation, Fourier transform, wavelet based are frequency domain methods of demosaicing. Further, machine learning and AI based demosaicing includes CNNs, GANs and transformer based AIs may also be used.

AI-based demosaicing is a method that may utilize machine learning to reconstruct images. For example, convolutional neural networks (CNNs are models trained end-to-end to map the mosaic input image directly to a full-color RGB output. They may learn to extract complex image features (edges, textures, inter-channel correlations) automatically from data, outperforming traditional hand-crafted algorithms. Additionally, Residual Networks (ResNets) may utilize “skip connections” to help train very deep networks effectively and improve performance by focusing on predicting high-frequency details (residuals) rather than the entire image from scratch. AI-based demosaicing may use U-Net and/or U-Net++ Architectures which are encoder-decoder networks. U-Net architectures utilize a U-shaped structure which efficiently fuses features at different resolutions, which is beneficial for reconstructing detailed images. Generative Adversarial Networks (GANs) involve a “generator” network producing a demosaiced image and a “discriminator” network assessing its realism. This adversarial process helps to generate images with better perceptual quality and fewer artifacts. Other models such as Residual Dense Networks (RDNs) and Spatial Adaptive Networks (SANets) may also be employed.

This facilitates interpolation by having DVS pixel uniformly replacing each APS color at the center of the pixel unit and enables larger area for DVS circuitry in the bottom die of the 3D stacked CIS process.

The synchronization between the DVS and APS frames makes the timing information accurate between both, which enables precise alignment, and higher quality of image reconstruction and deblurring.

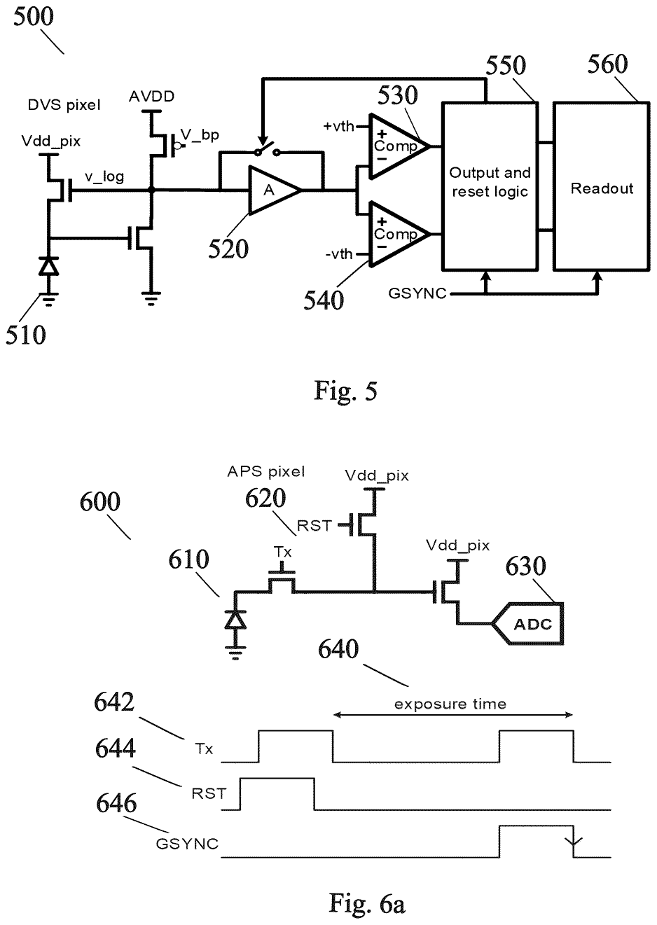

FIG. 5 illustrates one embodiment of DVS pixel circuitry. FIG. 5 shows a simplified circuit 500 for the DVS pixel, where the photodiode(“PD”) 510 is configured in a feedback to have logarithmic voltage, v_log, which is amplified by a gain 520, A, and the resulting output is compared with two thresholds, +vth 530 and −vth 540. The output and reset logic 550 detect if there is an event and decides if it is a positive or negative event, then resets the amplifier. The readout 560 is transferring the event data to the periphery for post-processing. The GSYNC signal registers the DVS frame status, by controlling the reset and readout logic.

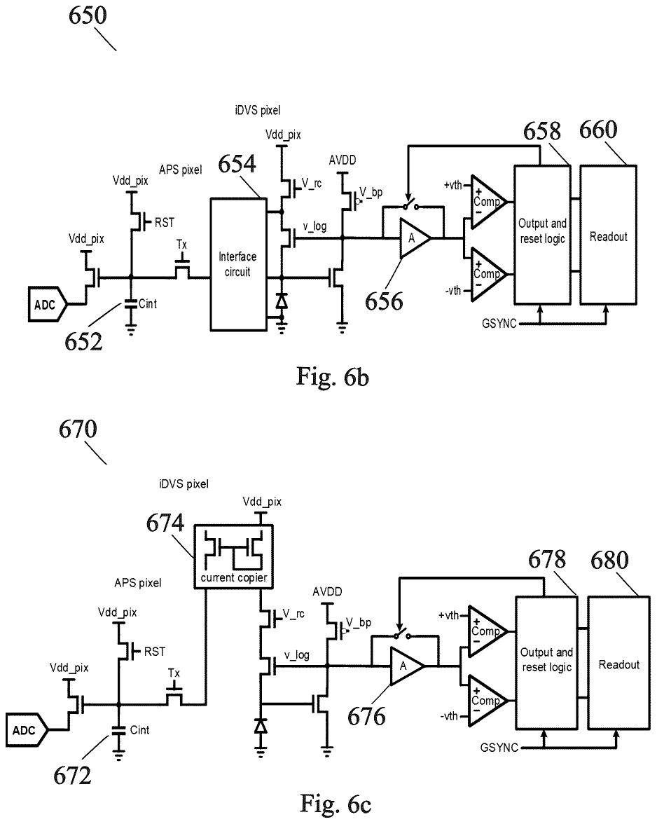

FIG. 6a illustrates one embodiment of APS pixel circuitry 600 and the corresponding synchronization timing 640. The circuit includes a photodiode 610, a 3T transistor design 620, and an analog-to-digital converter 630. FIG. 6.a illustrates a simplified circuit of the APS pixel 600, where the PD operates in the integration mode. The synchronization timing diagram 640 includes a Tx signal 642, an RST signal 644, and a GSYNC signal 646. The values of these signals are displayed against exposure time. The Transfer Gate Tx signal determines the APS exposure time, which is between the PD reset done by the Reset RST signal, and charge transfer when the integration phase ends. The GSYNC signal registers the DVS pixel status at the same time where the APS exposure ends, which renders a precise alignment between the APS frame and the DVS one.

FIG. 6b illustrates one embodiment of an iDVS pixel with APS function 650 and event detection. The pixel 650 includes an integrated Capacitor 652, an interface circuit 654, an amplifier 656, an output and reset logic block 658 and a readout block 660. FIG. 6b shows an alternate implementation of the DVS pixel, where the APS function, which is integration-based, is embedded through an interface circuit 654 to form the iDVS pixel. The interface circuit 654 manages the reset-signal levels and timing, which are integrated on the capacitor Cint. The DVS and the APS function can now be done concurrently in the iDVS. This iDVS pixel can further enhance the image quality in the hybrid sensor, by facilitating higher precision in the interpolation and reconstruction algorithms.

The structure of the iDVS includes a shared photodiode to measure incoming photons. Dual parallel circuitry permits separate pathways to process data. For example, the DVS pathway may include a continuous photoreceptor and a comparator circuit that monitors for changes in light intensity while the APS pathway may include a 3T or 4T pixel transistors to perform frame-based synchronous readout when a frame is requested or triggered.

FIG. 6c illustrates one embodiment of an iDVS pixel 670 using current copier circuit. The iDVS pixel includes an integrated APS pixel and a DVS pixel. The APS pixel includes an integration Capacitor 672. The iDVS pixel includes a current copier 674, an amplifier 676, dual comparators, an output and reset logic block 678 and a readout block 680. FIG. 6c shows the iDVS pixel using current copier 674. The use of a current copier minimizes the coupling to the DVS operation and simplifies the APS pixel readout. The current is copied from the PhotoDiode, and integrated on the integration capacitor, Cint. The corresponding signal is then converted by the Analog-to-Digital-Converter.

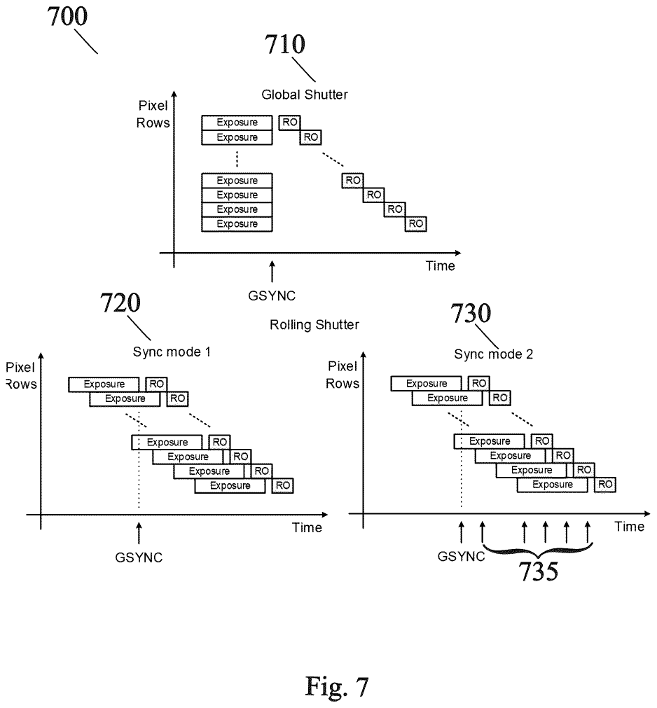

FIG. 7 illustrates one embodiment of synchronization of a DVS with rolling shutter and global shutter APS. As illustrated, FIG. 7 includes three graphs a global shutter graph 710, and two rolling shutter graphs 720 and 730. Rolling shutter graph 720 reflects a first sync mode while rolling shutter graph 730 reflects a second sync mode. More generally, FIG. 7 shows the synchronization between DVS sensor and APS with Global Shutter (“GS”) or Rolling Shutter (“RS”). Both GS and RS readout one row (or multiple rows) at a time, in a rolling manner. For GS, the exposure time is the same for all pixels, and the GSYNC signal can align with all the APS pixels at the end of exposure time. For RS, exposure time has different alignments for each APS pixel row, so two Sync modes can be employed. Sync mode 1, where the DVS frame is aligned once each APS frame, at the end of the first-row exposure. In some implementations, Sync Mode 1 may provide simpler processing and lower power consumption. Sync mode 2, where DVS frames are aligned at the end of each row exposure 735, as depicted in FIG. 7. Sync mode 2 would give a more accurate image reconstruction in the RS APS. Motion artifact (distortion) in RS sensors is a direct result of this rolling exposure across the rows in the pixel array. By having the DVS recording the motion dynamics at the end of each row exposure time, a precise reconstruction of the motion can be achieved with this precise timing alignment.

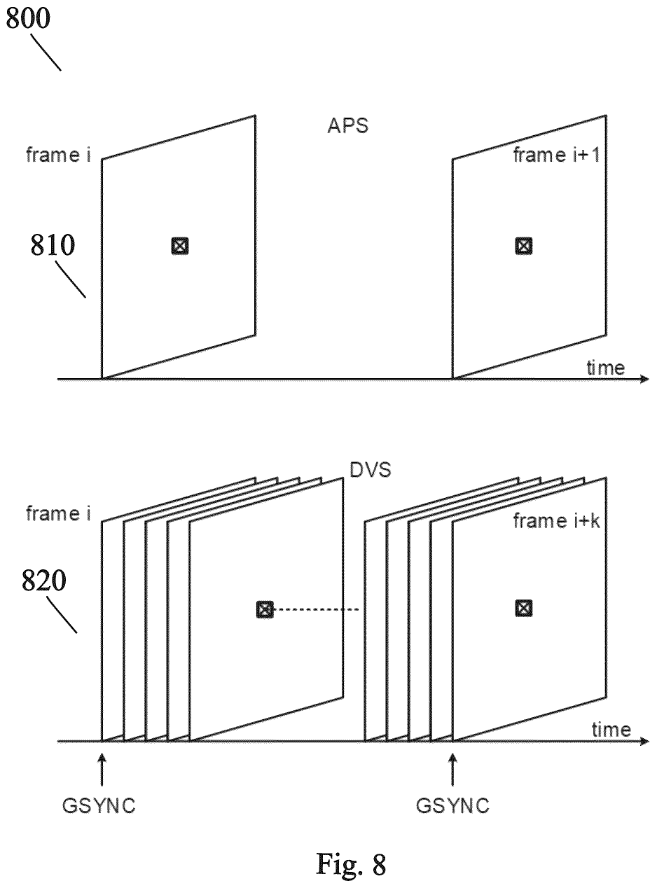

FIG. 8 illustrates one embodiment of scene synchronization between the DVS and APS frames. As illustrated, FIG. 8 includes two graphs, an APS frame graph 810 and a DVS frame graph 820. The FIG. 8 frame graphs depict the synchronization between APS and DVS frames, where for each k DVS frames there is one APS frame. The GSYNC signal synchronizes frames i and i+1 in APS with frames i and i+k in DVS. For example, if APS frames run at 100 fps, there is a 10 msec between two consecutive frames, and if DVS runs at 10 kfps, the DVS frames sample the 10 msec scene with 0.1 msec step. Between two APS images frame i and frame i+1 (10 ms apart), the DVS can produce 10 ms/0.1 ms=100 samples (commonly represented as pseudo-frames) or equivalently process events with ~0.1 ms timestamp resolution. Accordingly, the APS provides one snapshot every 10 ms and the DVS provides 100 “time slices” within those same 10 ms. Intuitively, an APS may see one blurry shot every 10 ms while the DVS captures motion with 0.1 ms timing leading to 100× more temporal detail. For example, the position and edges of a moving object may be tracked almost continuously.

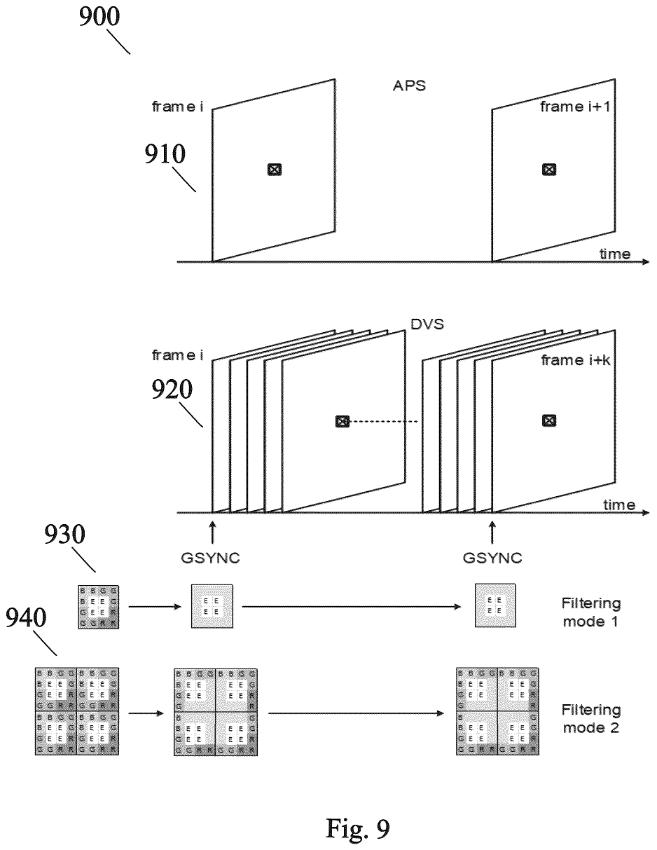

FIG. 9 illustrates one embodiment of event-based APS data filtering. As illustrated, FIG. 9 includes two graphs, an APS frame graph 910 and a DVS frame graph 920. The frame graphs depict the synchronization between APS and DVS frames, where for each k DVS frames there is one APS frame. The synchronization depicted in graphs 910 and 920 enables accurate data filtering of APS using the DVS pixels event status. The Event-Based APS data filtering can be done in two modes. Mode 1 930 filters the APS data based on the DVS pixel status in one pixel unit, which disables the read of the RGB APS pixels if there is not enough activity or changes in events in the DVS frames, which are between the frames i and i+1 in the APS. Mode 2 940 renders a more accurate filtering, can also be referred to as neighbor filtering, by comparing the DVS status in more than one DVS pixels, in the illustrated case, four DVS pixels. For example, a 2×2 pixel unit can only filter out the APS pixels in between, if there is no activity in the scene between two APS frames, as depicted in FIG. 9.

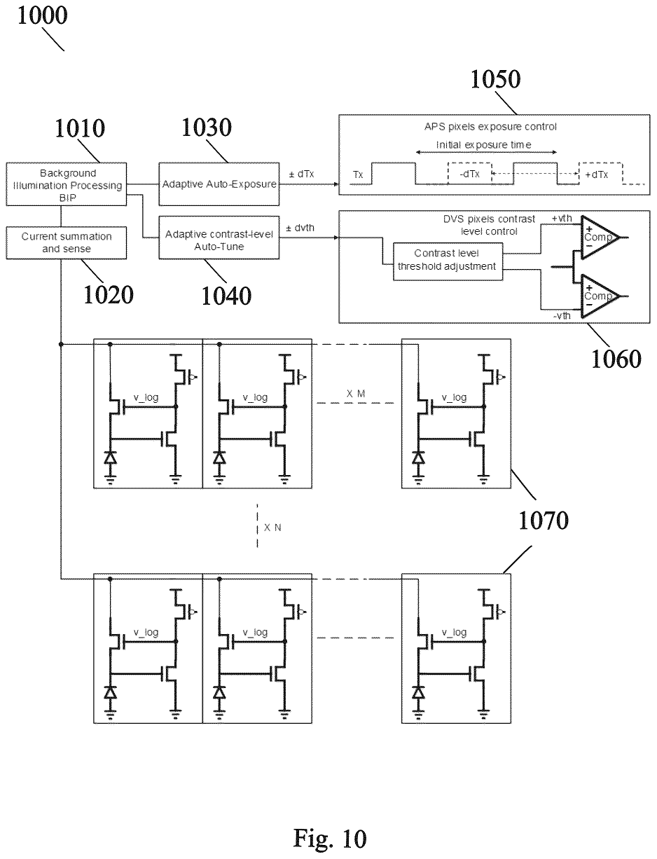

FIG. 10 illustrates one embodiment of APS Auto-Exposure and DVS Auto-Tune using the background light detection. FIG. 10 includes a background illumination block (BIP) 1010, a current summation and sense block 1020, an adaptive auto-exposure block 1030, and adaptive contrast level auto-tune block 1040, an APS pixels exposure control block 1050, a DVS pixel contrast level control block 1060 and an array of DVS pixels 1070. The DVS pixel can be used to perform Adaptive Auto-Exposure for the APS pixel array, and Adaptive Auto-Tune for the DVS pixels' contrast levels and thresholds, as shown in FIG. 10. The aggregate current in all the DVS pixels, is sensed and summed to determine the background illumination level. In other embodiments, histogram statistics and average brightness may also be utilized to determine background illumination level. In one example, the background illumination level may be bright, medium or dark. Based on the processing of the background light information, an Adaptive Auto-Exposure processor adds or subtracts time dTx to the APS pixel exposure time, based on the status of the background light and its change from frame to frame. If the background illumination level is bright, the dTx may decrease the exposure time. If the background illumination level is dark, the dTx may increase the exposure time. This adaptive step can be updated each DVS frame, which makes the AAE fast, and runs with minimal latency, corresponding to the DVS frame rate.

The background light information is used to Auto-Tune the thresholds of the DVS pixel, which determines the moving scene contrast level, as shown in FIG. 10. By adding or subtracting dvth, comparator thresholds can be adjusted, and the DVS contrast level can be adapted based on the background light conditions. For example, the auto-tune may decrease the threshold values with a bright background illumination level, which also serves to increasing the sensitivity of the sensor. Additionally, the auto-tune may increase the threshold values with a dark background illumination level, which allows the DVS to overcome noise sources like dark current and circuit noise.

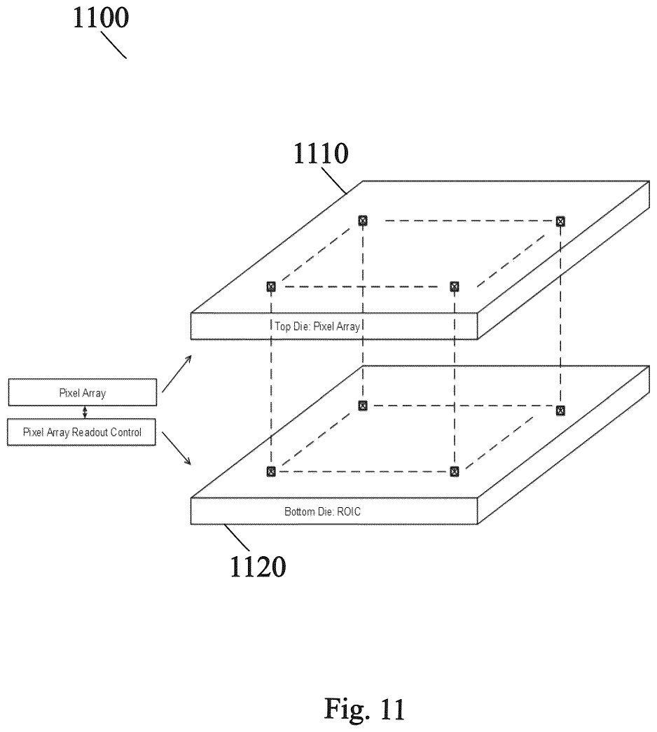

FIG. 11 illustrates one embodiment of a 3D CIS stacking process. FIG. 11 shows a conventional 3D CMOS Image Sensor stacking process, where the pixel array 1110 resides on the top die, while the Read-Out Integrated Circuits 1120 is implemented on the bottom die. Both dies are then connected through a die-to-die bonding, called Hybrid Bonds.

Hybrid bonding is a die-to-die interconnect technique that combines oxide bonding (molecular/hydrophilic wafer bonding) for mechanical strength and embedded metal-to-metal (Cu—Cu) connections for electrical contacts. Hybrid bonding achieves fine pitch (typically <10 μm, reaching down to ~1 μm) with low parasitic capacitance and high interconnect density (e.g., 10,000-100,000+ pixel-level connections). This enables per-pixel or per-column 3D stacking.

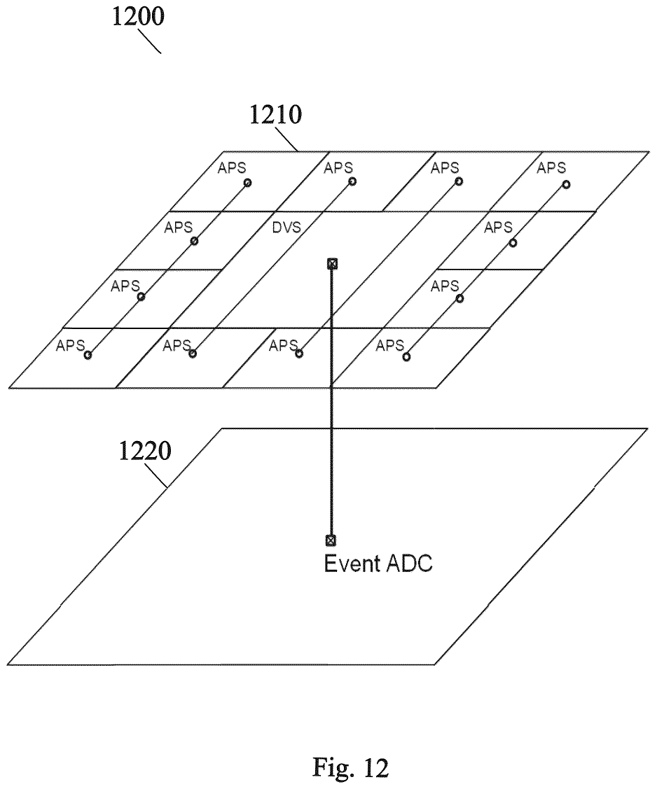

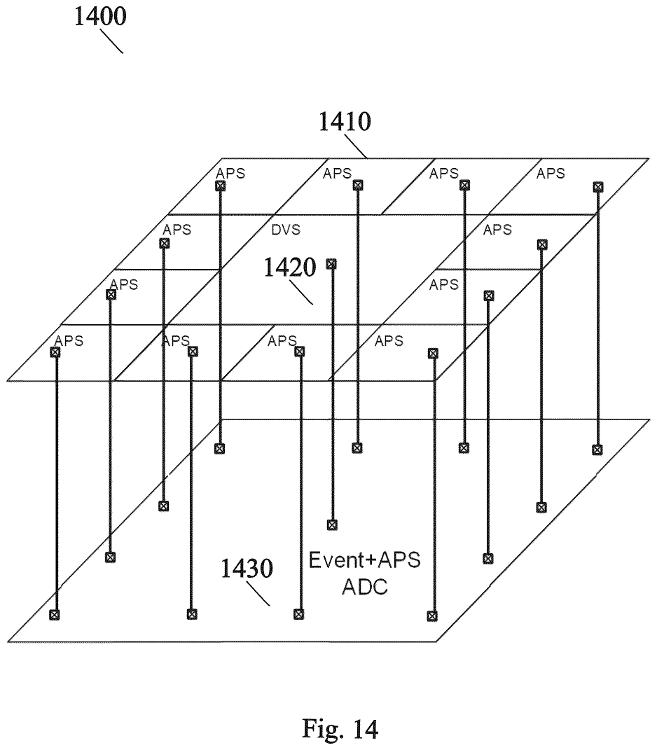

FIG. 12 illustrates one embodiment of a pixel unit with ADC per DVS pixel and APS routing to periphery ADC. The proposed pixel unit Analog-to-Digital Conversion can have two configurations. (FIG. 12 and FIG. 14). One configuration is shown in FIG. 12, where the Event Conversion 1220 of the DVS happens per pixel, and the APS pixels are routed at the top die 1210 to the periphery for conversion.

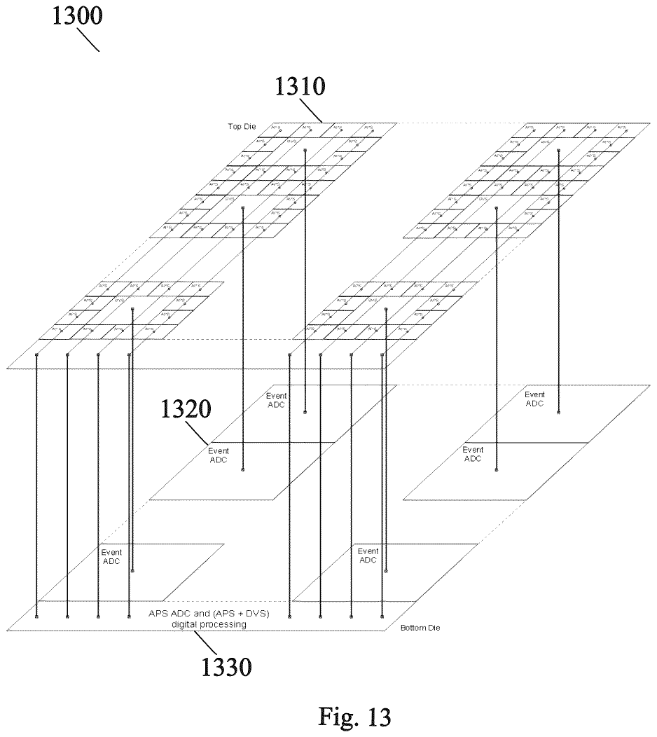

FIG. 13 illustrates one embodiment of a pixel array conversion in the Hybrid sensor. The pixel array in the top die 1310, a bottom die 1320 that includes Event Analog-to-Digital Converter ‘ADC’ array and the APS periphery ADC plus the digital processing block 1330. FIG. 13 illustrates the ADC conversion of the pixel array, where APS pixels are routed to the periphery in the top die, then through the Hybrid Bond to the bottom die periphery ADC. Both DVS and APS pixel post-processing 1330 is done on the bottom die.

FIG. 14 illustrates one embodiment of an ADC per pixel unit for DVS+APS signal conversion 1400. As illustrated, FIG. 14 includes a top die 1410 with a plurality of APS pixels around a DVS pixel 1420. The top die may be hybrid bonded to a bottom die 1430 having an analog to digital converter shared by the APS and DVS pixels. The second configuration of the pixel unit ADC is depicted in FIG. 14, where one ADC is used to convert the RGB APS pixels and the DVS pixel. This ADC can be shared by one pixel unit, or a cluster of pixel units.

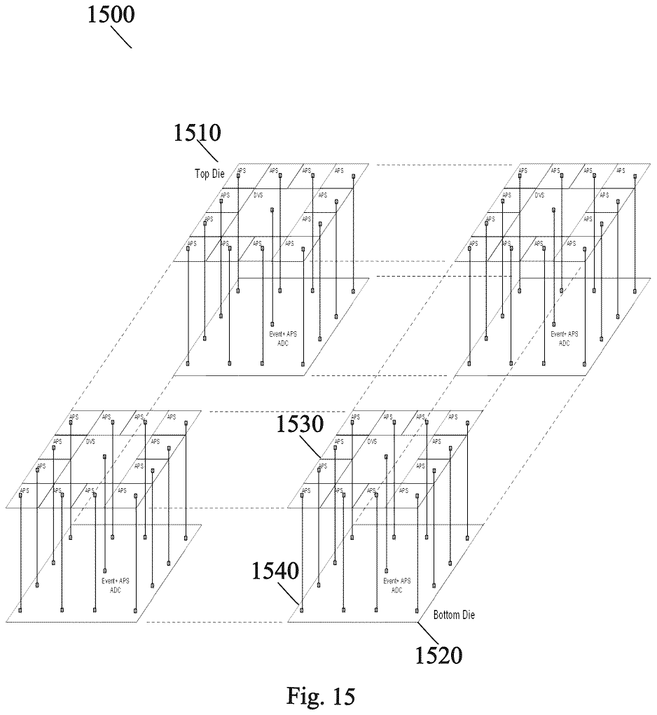

FIG. 15 illustrates one embodiment of a pixel array conversion with ADC per pixel unit. The stacked sensor 1500 illustrated in FIG. 15 includes a top die 1510, a bottom die 1520, a pixel unit 1530 and an Event and APS analog to digital converter 1540 associated with a corresponding pixel unit. The pixel array with an ADC per DVS+APS is shown in FIG. 15, where the area is smaller after removing the APS periphery ADC.

For post-processing the digital outputs of the pixels ADC conversion, a codesign of the sensor and its communication link to the digital processor will optimize the imaging system in terms of power and speed. This will enable shorter latency processing, and faster feedback cycle from the digital processor to the sensor controls for actuation and adaptation. An Augmented AI would be possible as well, with simple functions for feature extraction can be done on-chip, which reduces the amount of data the sensor sends off-chip for more complex and power-hungry AI processing.

In one embodiment, an augmented-AI on-chip may be performed by the image signal processor layer with a dedicated AI accelerator or neural processing units (NPUs). By placing the augmented AI capabilities on the chip, the system allows for more energy efficient and secure processing at the edge without relying on cloud connectivity. Some AI capabilities may include real time object detection and tracking, enhanced image quality through AI-powered noise reduction and image optimization, classification, motion segmentation, depth estimation, HDR fusion and predictive analytics.

Augmented AI on chip may run on the middle die via small neural network accelerators, vector MAC arrays, DSP blocks optimized for CNN operations, neural network based auto-exposure/auto-white balancing/demosaicing, DVS event denoising networks and real time motion saliency detectors. AI on chip may run on a per column or per region basis. When applied on a per column or per region basis, a neural network filter may replace a fixed function at the ISP. A machine learning model may be applied to conduct HDR synthesis and/or temporal denoising. At the pixel level, AI augmentation may include relatively small classifiers which determine if a pixel change is meaningful enough to constitute or trigger an event. In contrast to traditional applications, Augmented AI on chip reduces the need for sending full APS frames off chip and instead only send a moving object, a detected face, an anomalous activity, and other machine learned events. This reduces latency with AI running at the nanosecond rate compared to the microsecond rate on the sensor. System power requirement may also be reduced by avoiding memory transfers and associated bottlenecks.

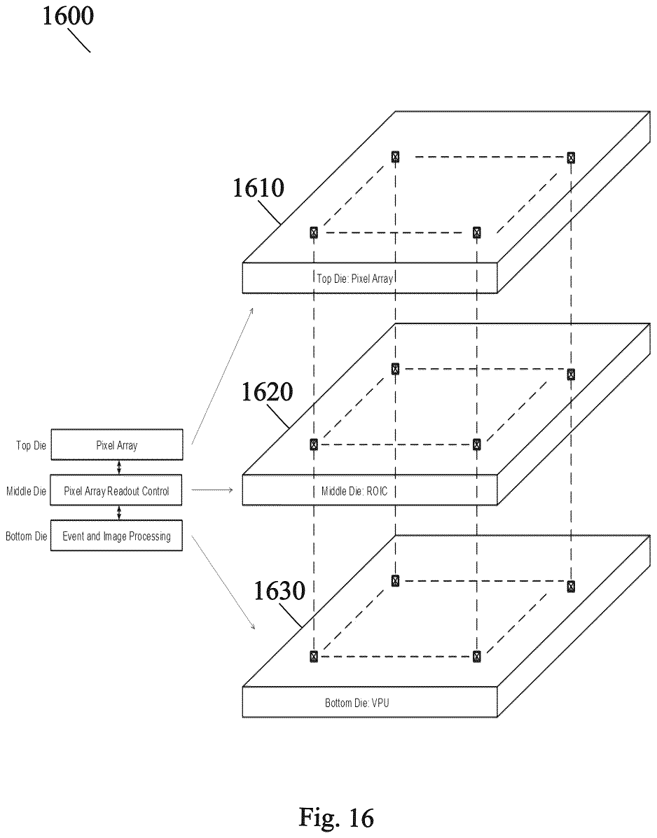

FIG. 16 illustrates one embodiment of a vertical integration 1600 of the sensor pixel array 1610, with ROIC 1620 and Vision Processor Unit (“VPU”) 1630. With the CIS 3D stacking, as illustrated in FIG. 16, a 3-die stack process can do the comprehensive processing, where the top die is for the pixel array, the middle die is for the ROIC, and the bottom die is for the customized Vision Processor Unit, otherwise known as a Vision Signal Processor (“VSP”), which does the Event and Image processing with high efficiency. The Vision Signal Processor may perform pixel level corrections, color reconstruction/enhancement, noise reduction, HDR/exposure fusion, geometric corrections, and advanced inference/analytics.

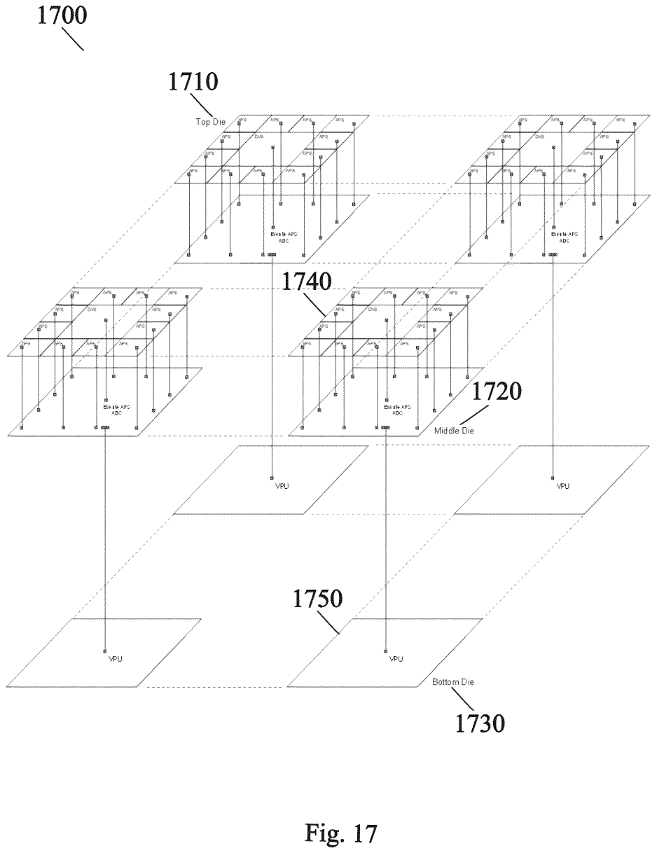

FIG. 17 illustrates one embodiment of routing in the vertical integration 1700 with the 3D stack CIS process. The vertical integration 1700 includes a top die 1710, a middle die 1720 and a bottom die 1730. The top die 1710 may include the APS+DVS pixel array hybrid bonded to a middle die 1720 which includes ROIC layer and a shared ADC for the Event based DVS and the APS. The bottom die 1730 shows a plurality of VPUs in operable communication with the middle die. FIG. 17 shows the short and direct routings of the communication link between the pixel ROIC and the VPU. The VPU can be one per pixel unit, or one for a cluster of pixel units, depending on the processing algorithm used.

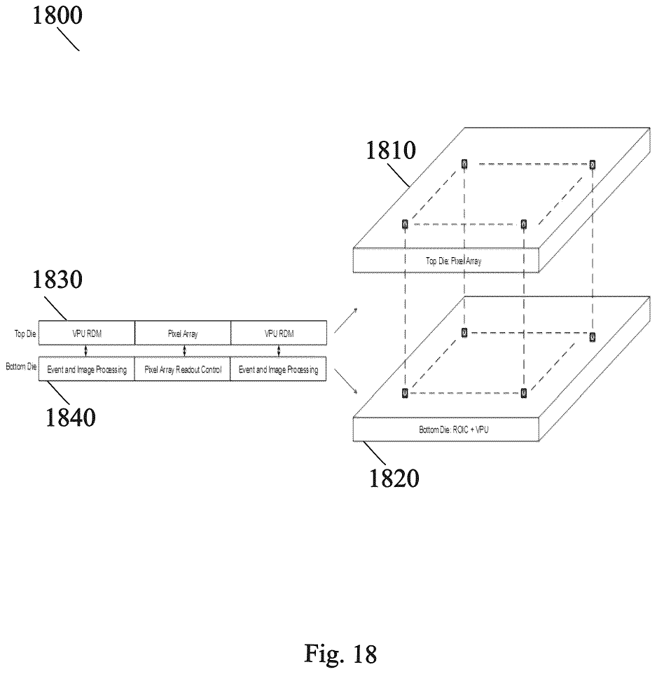

FIG. 18 illustrates one embodiment of vertical integration 1800 of pixel ROIC and VPU in a 2-die stacking process. The 2-die stacking process produces a top die 1810 holding the pixel array and a bottom die 1820 holding the ROIC and the VPU.

In a 2-die stacking process, which is lower cost than the 3-die stacking, with faster turn-around manufacturing time, FIG. 18 shows the optimized communication links between the pixel ROIC and the corresponding VPUs, where the top die 1830 has the pixel array and the VPU Routing Distribution Matrix, and the bottom die 1840 has the readout and control ROIC with the VPU units, which do the event and image processing.

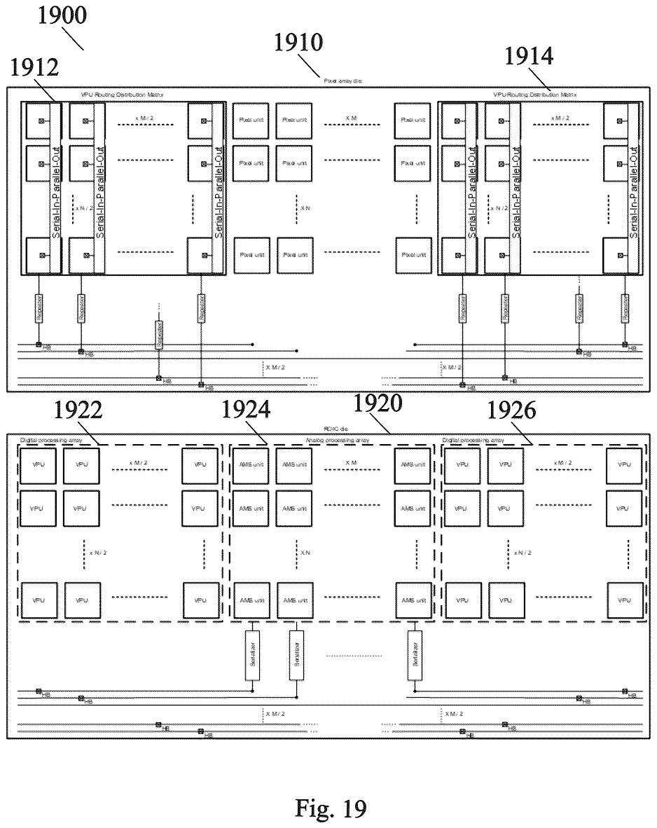

FIG. 19 illustrates one embodiment of communication links between the pixel ROIC and the VPUs in 2-die stacking process 1900. FIG. 19 shows a plan view of the two dies, a top die 1910 (Pixel Array Die) and a bottom die 1920 (ROIC die). The ROIC die has the Analog Mixed Signal units 1924, which contain the ADC conversion per pixel unit or cluster of such. The ROIC die also has two VPU digital processing arrays, 1922 and 1926. The digital outputs of the array columns are serialized at the periphery and sent to the top die through Hybrid Bonds. At the top die, the serialized output is passed by repeaters for better signal integrity and then deserialized through a Serial-In-Parallel-Out to the Routing Distribution Matrix. The RDM units 1912 and 1914 match the VPU units' size and connect to the VPU in the bottom die through HBs. This saves area at the bottom die, while exploiting the top die to do the communication link routings. The communication link can be two-way to enable shorter latency and fast feedback between the pixel unit and its corresponding VPU unit.

The vertical integration of the pixel ROIC and the VPUs in the 3D stacking CIS process shortens the latency and minimizes the power of the overall imaging system, by avoiding the need for a large number of high-speed Input/Output ports, if the processing is done off-chip. This enables efficient post-processing of the sensor output and opens the door for Augmented AI on-chip, where inference and feature extraction algorithms can be efficiently done, and this consequently minimizes the data sent off-chip for more complex AI.

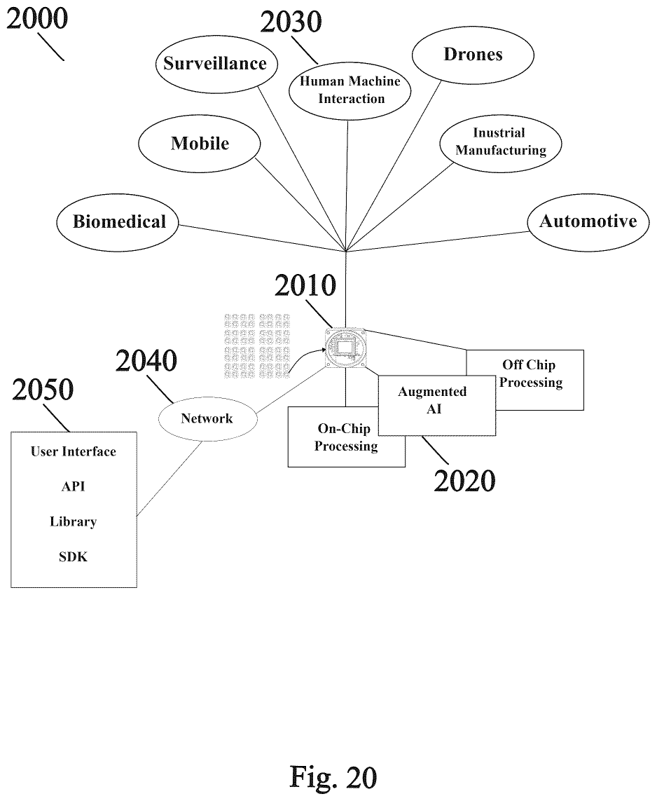

FIG. 20 illustrates a schematic diagram of a system for performing readout of an event-based sensor. FIG. 20 illustrates a schematic diagram of a vision sensor system according to one embodiment. The vision sensor system 2000 depicted in FIG. 20 includes a sensor/array of sensors 2010, a suite of processing blocks 2020, including on-chip processing, augmented AI and off chip processing. The schematic further includes a network 2040 in communication with the sensor/array of sensors and a software stack 2050. The software 2050 may include a graphical user interface, an Application Programming Interface (API), a software library, and a software development kit (SDK). The software may include modules customized to operate in a set of environment specific applications 2030. In one example, the set of environment specific applications may include biomedical, mobile, human machine interaction, industrial/manufacturing, drones and surveillance, among others.

In mobile and embedded imaging applications, event-based vision enables motion-aware reconstruction and stabilization. Continuous temporal sampling allows fine-grained estimation of motion vectors, which can be used to correct blur, track fast-moving features, or reconstruct intensity images with improved sharpness. These capabilities are especially valuable when either the sensor or the observed scene is in motion.

For human-machine interaction, event-driven sensing supports high-precision tracking of eye movements, gestures, and fine motor actions. Because temporal resolution is not constrained by a global frame rate, rapid micro-movements can be detected with minimal latency. This enables responsive interaction in immersive systems and allows detection of high-frequency visual phenomena such as flicker or subtle motion cues across a wide range of illumination levels.

In surveillance contexts, event-based vision enables detection of critical motion patterns—such as falls, intrusions, or abnormal activity—while inherently limiting the capture of identifiable visual detail. Since the sensor reports changes rather than full images, privacy-preserving observation is possible without sacrificing temporal fidelity or responsiveness. Similar advantages apply to crowd analysis, traffic monitoring, and visual odometry, where continuous motion estimation benefits from precise event timing and sparse data representation.

Industrial and manufacturing applications benefit from the ability of event-based sensors to observe motion over an extremely wide temporal bandwidth. The effective temporal resolution corresponds to frame rates on the order of hundreds of thousands to millions of frames per second, enabling analysis of vibrations, oscillations, and transient phenomena that are inaccessible to conventional cameras. This makes the technology well suited for high-speed object counting, particle tracking, conveyor monitoring, and predictive maintenance through vibration analysis.

In drones and robotic systems, event-based vision supports accurate tracking of edges, markers, and structural features in three dimensions. The high temporal precision improves pose estimation and motion prediction, which are critical for closed-loop control in manipulation, navigation, and pick-and-place automation. Continuous event streams allow robots to react to changes in real time rather than waiting for the next image frame.

For automotive and mobility systems, event-driven perception enhances object detection and tracking in challenging conditions, including high relative speeds, rapid lighting transitions, and scenes with extreme contrast. The sensors described herein also lend their advantages to autonomous driving tasks. Event-based sensing also supports real-time monitoring of driver behavior by detecting fine eye and facial movements, enabling rapid assessment of attention and alertness.

In biomedical and scientific applications, the ability to detect microscopic or subtle motion at high temporal resolution enables accelerated analysis of biological processes. Event-based sensors can identify motion signatures that occur on very short time scales, significantly reducing the duration of procedures that rely on visual observation of dynamic samples.

Across these application domains, the unifying technical advantage of event-based vision lies in its asynchronous, data-efficient representation of visual information. By encoding only meaningful temporal changes with precise timing, event-based systems provide high-speed, low-latency perception while minimizing power, bandwidth, and computational overhead compared to traditional frame-based imaging architectures.

While the foregoing invention has been described in some detail for purposes of clarity and understanding, it will be appreciated by one skilled in the art, from a reading of the disclosure, that various changes in form and detail can be made without departing from the true scope of the invention.

1. A pixel array, comprising:
a first pixel unit composed of a first microlens, a first color filter, and a first photodiode;
a second pixel unit composed of a second microlens, a second color filter, and a second photodiode;
a third pixel unit composed of a first microlens, a third color filter, and a third photodiode;
a fourth pixel unit composed of a fourth microlens, a fourth color filter, and a fourth photodiode;
a quadrant pixel array composed of the first, second, third and fourth pixel units wherein the quadrant pixel unit includes a plurality of active pixel sensors and one or more dynamic vision sensors.

2. The pixel array of claim 1, wherein the plurality of active pixel sensors is associated with a primary color filter.

3. The pixel array of claim 1, wherein at least one of the one or more dynamic vision sensors is uniformly distributed among the plurality of active pixel sensors.

4. The pixel array of claim 1, wherein the at least one of the one or more dynamic vision sensors includes an all-pass color filter.

5. The pixel array of claim 1, further comprising:
a plurality of quadrant pixel arrays.

6. The pixel array of claim 1, further comprising:
a quad Bayer color filter array wherein a group of adjacent pixels within the quad Bayer color filter array are set to a single primary color filter.

7. The pixel array of claim 1, further comprising:
an augmented on chip artificial intelligence component.

8. A system for image sensing and processing, comprising:
an active pixel sensor circuit including a photodiode, one or more transistor design, and an analog to digital converter;
an integration dynamic vision sensor including an integration capacitor, an amplifier, a dual comparator, an output and reset logic block and a readout block;
a synchronization timing including a transfer gate signal, a reset signal and a global synchronization signal, the synchronization rendering alignment between an active pixel sensor frame and an integration dynamic vision sensor frame.

9. The system for image sensing and processing of claim 8, further comprising:
an interface circuit embedding a function of the active pixel sensor within the integration dynamic vision sensor.

10. The system for image sensing and processing of claim 8, wherein the photodiode is shared between the active pixel sensor circuit and the integration dynamic vision sensor via dual parallel circuitry providing a plurality of distinct pathways for data processing.

11. The system for image sensing and processing of claim 8, further comprising:
a current copier copying a current from the photodiode and integrating the current on the integration capacitor.

12. The system for image sensing and processing of claim 8, wherein the synchronization timing is performed with a rolling shutter.

13. The system for image sensing and processing of claim 8, wherein the synchronization timing is performed with a global shutter.

14. The system for image sensing and processing of claim 8, wherein the synchronization timing includes a scene synchronization between a plurality of active pixel sensor frames and a plurality of integration dynamic vision sensor frames.

15. The system for image sensing and processing of claim 8, wherein the synchronization timing enables data filtering of the plurality of active pixel sensor frames based, at least in part, on one or more integration dynamic pixel sensor status variables.

16. The system for image sensing and processing of claim 8, further comprising:
a background illumination block;
a current summation and sense block;
an adaptive auto-exposure block;
an adaptive contrast level auto-tune block.

17. The system for image sensing and processing of claim 16, wherein an aggregate current representative of a plurality of integration dynamic vision sensor currents is summed and sensed at the current summation block.

18. The system for image sensing and processing of claim 16, wherein a background illumination level is determined, at least in part, of the aggregate current representative of the plurality of integration dynamic vision sensor currents.

19. The system for image sensing and processing of claim 16, wherein the adaptive auto-exposure block adjusts a pixel exposure time based, at least in part, on the background illumination level.

20. The system for image sensing and processing of claim 16, wherein the adaptive contrast level auto-tune block adjusts a positive threshold and a negative threshold at the dual comparator based, at least in part, on the background illumination level.
